(19) United States
(12) Patent Application Publication
(10) Pub. No.: US 2013/0257563 A1
(43) Pub. Date: Oct. 3, 2013

(54) MULTI-CHANNEL MODE CONVERTER AND ROTARY JOINT OPERATING WITH A SERIES OF TE OR TM MODE ELECTROMAGNETIC WAVE

(71) Applicants: TSUN-HSU CHANG, HSINCHU (TW); NAI-CHING CHEN, HSINCHU (TW)

(72) Inventors: TSUN-HSU CHANG, HSINCHU (TW); NAI-CHING CHEN, HSINCHU (TW)

(73) Assignee: NATIONAL TSING HUA UNIVERSITY, HSINCHU (TW)

(21) Appl. No.: 13/494,089

(22) Filed: Jun. 12, 2012

(30) Foreign Application Priority Data
Mar. 27, 2012 (TW) 101110559

(51) Int. Cl. H01P 5/12; H01P 1/16; H01P 1/06

(52) U.S. Cl. 333/137; 333/256; 333/21 R

(57) ABSTRACT

A multi-channel mode converter operating with a series of TE or TM mode electromagnetic wave includes a plurality of coaxial waveguides arranged in overlay configuration. By controlling radius ratio and the number of coupling aperture of each coaxial waveguide, high power and high purity of operating mode of electromagnetic wave can be obtained and the major parasitic mode of electromagnetic wave can be suppressed, so as to avoid crosstalk between coaxial waveguides. A rotary joint including the above-mentioned mode converter with multi-channel is also disclosed.

### BACKGROUND OF THE INVENTION

1. Field of the Invention

The present invention relates to a mode converter and rotary joint of microwave, and more particularly to a multi-channel mode converter and rotary joint operating with a series of TE or TM mode electromagnetic wave.

2. Description of the Prior Art

Mode converters can transform a mode of electromagnetic wave to another mode of electromagnetic wave. For example, when using rotary joints for radar system and satellite system, mode converters can transform communication electromagnetic wave from general transmission mode to another mode which exempts from rotating influence or transform back without energy loss. As to dual channel mode converters, conventionally, two different modes of electromagnetic wave are used for operation and different mode converters must be designed accordingly, which makes the structure of the dual channel mode converter more complicated and limits the channel number. Besides, TEM mode electromagnetic wave is required in outer channels for operating conventional multi-channel converters, and TEM electromagnetic wave leads to heavy energy loss.

To solve the problems mentioned above, a multi-channel mode converter and rotary joint should be developed.

### SUMMARY OF THE INVENTION

The present invention is directed to a multi-channel mode converter and rotary converter operating with a series of TE or TM mode electromagnetic wave, wherein a plurality of coaxial waveguides are sleeved to each other and each of them respectively induces electromagnetic wave in proper mode to obtain high power and high purity electromagnetic wave and prevent crosstalk between each coaxial waveguide.

According to an embodiment, the multi-channel mode converter operating with a series of TE or TM mode electromagnetic wave comprises a waveguide element. The waveguide element comprises a first mode converting structure and a second mode converting structure. The first mode converting structure comprises a first waveguide and N first rectangular waveguides, wherein N is a positive integer greater than 1. The first waveguide has a circular outer interface. A first port of the N first rectangular waveguides is respectively connected to the outer interface of the first waveguide and arranged uniform radially. A long axis of the first port of the N first rectangular waveguides is axially parallel to the first waveguide. A second port of the N first rectangular waveguides forms at least one first output/input port of the first mode converting structure. The second mode converting structure comprises a second waveguide and M second rectangular waveguides, wherein M is a positive integer greater than 1. The second waveguide has an outer interface and an inner interface which are circular and arranged coaxially. The first waveguide is sleeved into the second waveguide. A first port of the M second rectangular waveguides is respectively connected to the outer interface of the second waveguide and arranged uniform radially. A long axis of the first port of the second rectangular waveguide is axially parallel to the second waveguide. A second port of the M second rectangular waveguides forms at least one first output/input port of the second mode converting structure, wherein a port of the first waveguide and the second waveguide respectively forms a second output/input port of the second mode converting structure.

According to another embodiment, the multi-channel mode rotary joint operating with a series of TE or TM mode electromagnetic wave comprises two aforementioned waveguide elements. The two waveguide elements are arranged coaxially as the second output/input ports of the first mode converting structure and the second mode converting structure are arranged in opposition.

The objective, technologies, features and advantages of the present invention will become more apparent from the following description in conjunction with the accompanying drawings, wherein certain embodiments of the present invention are set forth by way of illustration and examples.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic diagram illustrating the correlation between the radius ratio of the coaxial waveguides and the cutoff frequency of the TEₘ₁ mode electromagnetic wave;

FIG. 2 is a schematic diagram illustrating the waveguide structure of the multi-channel mode converter operating with a series of TE or TM mode electromagnetic wave according to an embodiment of the present invention;

FIG. 3 is a schematic diagram illustrating the waveguide structure of the multi-channel mode converter operating with a series of TE or TM mode electromagnetic wave from another direction according to an embodiment of the present invention;

FIG. 4 is a schematic diagram illustrating the first mode converting structure of the multi-channel mode converter operating with a series of TE or TM mode electromagnetic wave multimedia player device according to an embodiment of the present invention;

FIG. 5 is a schematic diagram illustrating the second mode converting structure of the multi-channel mode converter operating with a series of TE or TM mode electromagnetic wave multimedia player device according to an embodiment of the present invention;

FIG. 6 is a schematic diagram illustrating the third mode converting structure of the multi-channel mode converter operating with a series of TE or TM mode electromagnetic wave multimedia player device according to an embodiment of the present invention;

FIG. 7 is a schematic diagram illustrating the simulation results of the first mode converting structure of the multi-channel mode converter operating with a series of TE mode electromagnetic wave multimedia player device according to an embodiment of the present invention;

FIG. 8 is a schematic diagram illustrating the simulation results of the second mode converting structure of the multi-channel mode converter operating with a series of TE mode electromagnetic wave multimedia player device according to an embodiment of the present invention; and

FIG. 9 is a schematic diagram illustrating the simulation results of the third mode converting structure of the multi-channel mode converter operating with a series of TE mode electromagnetic wave multimedia player device according to an embodiment of the present invention.

### DESCRIPTION OF THE PREFERRED EMBODIMENT

The detail description is provided below and the preferred embodiments described are only for the purpose of description rather than for limiting the present invention.

When using rotary joint for operation, electromagnetic wave must exempt from rotating influence and conforms to circular symmetry of electromagnetic field, for example, TE₀₁ mode electromagnetic wave with properties of torodial surface current. Radius rₒ and rᵢ of outer conductors and inner conductors of coaxial structures can be changed to obtain extra freedoms to adjust and perform electromagnetic wave separation. However, it is a severe challenge to transform coaxial TE₀₁ mode electromagnetic wave with high purity because low order parasitic mode wave may increase dramatically with decreasing radius ratio to cause harmful mode competition. In multi-channel system, electromagnetic wave under low order parasitic mode wave may further cause crosstalk between channels.

Cutoff frequency of coaxial TEₘₙ mode electromagnetic wave can be founded by deriving the characteristic value xₘₙ from the equation (1) to find the boundary in the system's frequency response.

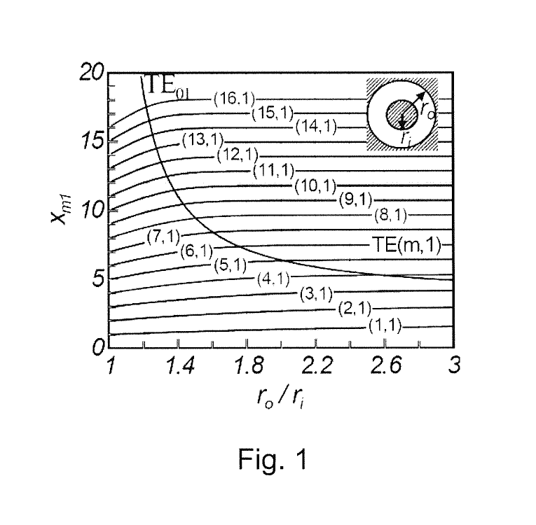

Jₘ′(xₘₙ)Yₘ′(xₘₙrᵢ/rₒ)−Jₘ′(xₘₙrᵢ/rₒ)Yₘ′(xₘₙ)=0 (1)

Wherein, Jₘ′ and Yₘ′ are firth derivatives of the first kind and second kind of Bessel functions. When the radius rₒ of outer conductor is much greater than the radius rᵢ of the inner conductor, Yₘ′(xₘₙrᵢ/rₒ) approaches infinity, and equation (1) can be simplified as Jₘ′(xₘₙ)=0, which can determine the cutoff frequency of the circular waveguide. Referring to FIG. 1, when the radius ratio rₒ/rᵢ decreases (i.e. rᵢ approaches rₒ), cutoff frequency of coaxial TEₘₙ mode electromagnetic wave (m≠0, n=1) also declines. Furthermore, cutoff frequency of coaxial TE₀₁ mode electromagnetic wave approaches infinity when rᵢ approaches rₒ. By this way, TE₀₁ mode electromagnetic wave with larger cross-sectional dimension is allowed to be stimulated in coaxial waveguides.

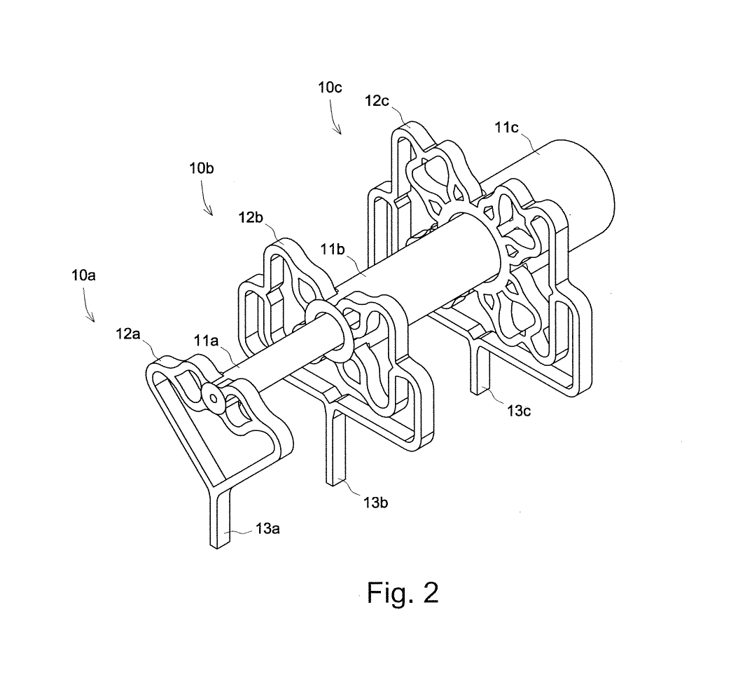

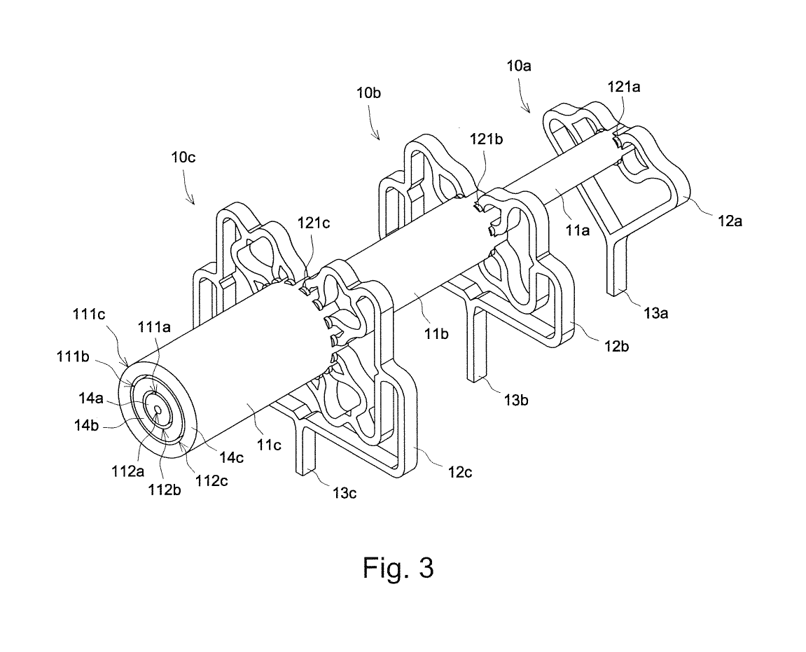

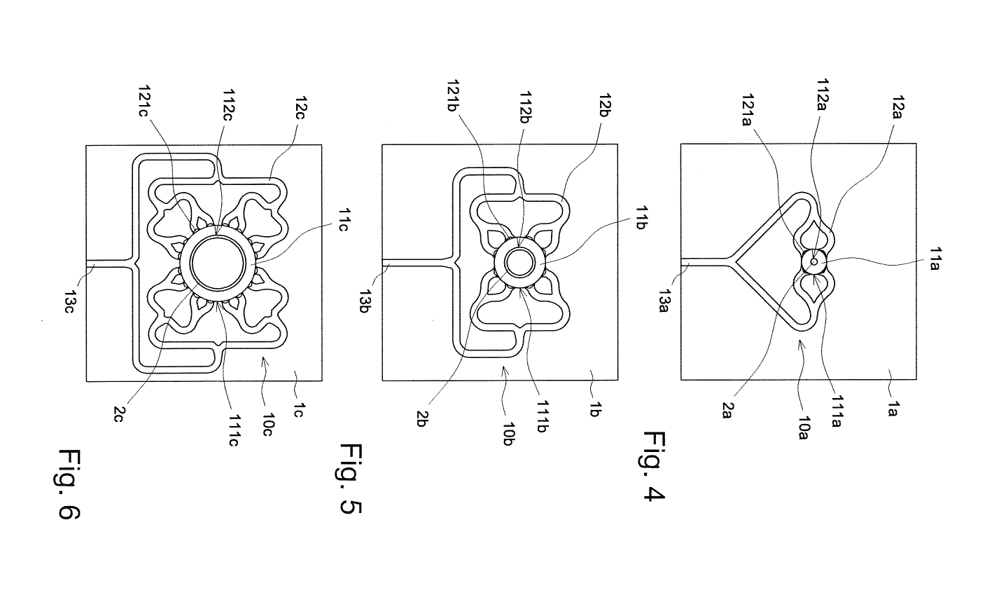

According to an embodiment of the present invention, the multi-channel mode converter operating with a series of TE or TM mode electromagnetic wave comprises a waveguide element. The waveguide element can be one piece device or composed of multiple devices. Referring to FIG. 4 to FIG. 6, for example, waveguide elements comprise multiple conductive bulk components 1a, 1b and 1c, cylinder component 2a and hollow cylinder components 2b and 2c. To make the description concise and better understood, FIG. 2 and FIG. 3 only illustrates the waveguide structure of the waveguide element.

Referring to FIG. 2 to FIG. 6, the waveguide element comprises a first mode converting structure 10a and a second mode converting structure 10b. Preferably, the waveguide element further comprises a third mode converting structure 10c. Each mode converter is separated to form multiple channels.

The first mode converting structure 10a comprises a first waveguide 11a and N first rectangular waveguides 12a, wherein N is a positive integer greater than 1. The first waveguide 11a has an outer interface 111a and an inner interface 112a which are circular and coaxially arranged. In other words, the first waveguide 11a is a coaxial waveguide. A first port of the N first rectangular waveguides is respectively connected to the outer surface 111a of the first waveguide and the long axis of the first port is axially parallel to the first waveguide 11a. Besides, The N first rectangular waveguides 12a are uniform radially arranged around the first waveguide 11a. A second port of the N first rectangular waveguides forms at least one first output/input port 13a of the first mode converting structure 10a. A port of the first waveguide 11a forms a second output/input port 14a of the first mode converting structure 10a.

The second mode converting structure 10b comprises a second waveguide 11b and M second rectangular waveguides 12b, wherein M is a positive integer greater 1. Similarly, the second wave guide 11b has an outer interface 111b and an inner interface 112b which are circular and arranged coaxially. The first waveguide 11a is sleeved into the second waveguide 11b. It could be understood that the inner interface 112b of the second waveguide 11b is larger than the outer interface 111a of the first waveguide 11a. A first port of the M second rectangular waveguides 12b is respectively connected to the outer interface 11b of the second waveguide 11b and the long axis of the first port is axially parallel to the second waveguide 11b. Besides, the M second rectangular waveguides 12 surround the second waveguide 11b uniform radially. A second port of the M second rectangular waveguides 12b forms at least one first output/input port 14b of the second mode converting structure 10b and a port of the second waveguide 11b forms a second output/input port 14b of the second mode converting structure 10b.

The third mode converting structure 10c comprises a third waveguide 11c and L third rectangular waveguides 12c, wherein L is a positive integer greater than 1. Similarly, the third waveguide 11c has an outer interface 111c and an inner interface 112c which are circular and coaxially arranged, and the second waveguide 11b is sleeved into the third waveguide 11c. A first port of the L third rectangular waveguides 12c is respectively connected to the outer interface 111c of the third waveguide 11c and the long axis of the first port is axially parallel to the third waveguide 11c. Besides, the L third rectangular waveguides 12c surround the third waveguide 11c uniform radially. A second port of the L second rectangular waveguides 12c forms at least one first output/input port 13c of the third mode converting structure 10c. A port of the third waveguide 11c forms a second output/input port 14c of the third mode converting structure 10c.

According to an embodiment, the first port of the first rectangular waveguide 12a, the second rectangular waveguide 12b and the third rectangular waveguide 12c can be tetragonal symmetry in shape. In one embodiment, the waveguide element can comprises at least one plate conductor (not shown in the figure) which covers the first port of at least one of the first rectangular waveguide 12a, the second rectangular waveguide 12b and the third rectangular waveguide 12c, and the plate conductor has at least one coupling aperture which is column shaped and tetragonal symmetry. The long axis of the coupling aperture is axially parallel to the first waveguide 11a, the second waveguide 11b and the third waveguide 11c. Other coupling structures which can stimulate mode electromagnetic wave while operating shall fall with the spirit and the scope of the present invention.

According to an embodiment, the second ports of the plurality of the first rectangular waveguides 12a can converge into a single port, which is the first output/input port 13a of the first mode converting structure 10a. Similarly, the second ports of the plurality of the second rectangular waveguides 12b and the third rectangular waveguides 12c can respectively converge into a single port, which are the first output/input port 13b of the second mode converting structure 10b and the first output/input port 13c of the third mode converting structure 10c.

Take the first mode converting structure 10a for example. A mode electromagnetic wave is provided at the N first waveguides 12a around the first waveguides 11a, wherein the electrical field direction is axially orthogonal to the first waveguide 11a, for example but not limited to TE₁₀ mode. Therefore, the electrical field direction of the electromagnetic wave provided at the first rectangular waveguides 12a which uniformly surround the first waveguide 11a deflects clockwise or counterclockwise; energy and phase of each electromagnetic wave provided at the first rectangular waveguide 12a is the same, thereby stimulating TE₀₁ mode electromagnetic wave with circle electrical field at the first waveguide 11a.

In order to generate electromagnetic wave with equal energy and phase, the number N of the first rectangular waveguide 12a is equal to 2ⁿ, wherein n is a positive integer greater than or equal to 2. Besides, every two adjacent of the first rectangular waveguides 12a gradually converge into a Y-shaped or T-shaped structure and finally converge into a single port, i.e. the first output/input port 13a. Accordingly, each Y-shaped or T-shaped structure can be an energy splitter, which allows the single input port to generate electromagnetic waves with equal energy and phase at multiple output ports. In an embodiment, the number M of the second rectangular waveguides 12b is equal to 2ⁿ, wherein the n is a positive integer greater than or equal to 3; the number L of the third rectangular waveguide 12c is equal to 2ⁿ, wherein the n is a positive integer greater than or equal to 4.

Referring to FIG. 3, each of the first rectangular waveguides 12a faces the second output/input port 14a of the first mode converting structure 10a to axially extend an arc protrusion 121a at the first port of the first rectangular waveguide 11a. The arc protrusion 121a can mitigate rough surface due to connection between the first rectangular waveguide 12a and the first waveguide 11a, to reduce reflection and improve transforming efficiency. Similarly, each of the second rectangular waveguides 12b faces the second output/input port 14b of the second mode converting structure 10b to axially extend an arc protrusion 121b at the first port of the second rectangular waveguide 12b; each of the third rectangular waveguides 12c faces the second output/input port 14c of the third mode converting structure 10c to axially extend an arc protrusion 121c at the first port of the third rectangular waveguide 12c.

As known, azimuthal component presents as Γ=m+jN, wherein N is the number of electromagnetic waves entering the coaxial waveguides, that is the number of the rectangular waveguides 12a, 12b and 12c, j=0, ±1, ±2, . . . . For the TE₀₁ mode electromagnetic wave, m=0, so that Γ=0, ±4, ±8 . . . . Take the first mode converting structure 10a for example. When frequency is higher than the cutoff frequency, TE₀₁, TE₄₁, TE₈₁ . . . mode electromagnetic waves are stimulated correspondingly. As shown in FIG. 1, when the radius ratio rₒ/rᵢ of the coaxial waveguides of the first mode converting structure 10a is greater than 2.58, stimulation of major competition mode electromagnetic wave (TE₄₁ mode) can be suppressed. Similarly, when the radius ratio rₒ/rᵢ of the coaxial waveguides of the second mode converting structure 10b is greater than 1.5, stimulation of major competition mode electromagnetic wave (TE₈₁ mode) can be suppressed. As to the major competition mode of the third mode converting structure 10c (TE_{16,1}), the cutoff frequency of the electromagnetic wave is 118.8 GHz, which is much higher than W-band (75 GHz˜110 GHz), so that parasitic oscillations will not happen for the third mode converting structure 10c.

In one embodiment, the radius of the outer interface 111a of the first waveguide 11a of the first mode converting structure 10a is 2.43 mm and 0.60 mm is for the inner interface 112a; the radius ratio rₒ/rᵢ is 4.05. Simulation results by using the software, High Frequency Structure Simulator (HFSS), which is developed by Ansoft, are demonstrated in FIG. 7. TE₀₁ mode electromagnetic wave with high purity (>99.9%) can be obtained via the first mode converting structure 10a, wherein the −1 dB transmission bandwidth is generated from 88 GHz to 102 GHz (14.9%).

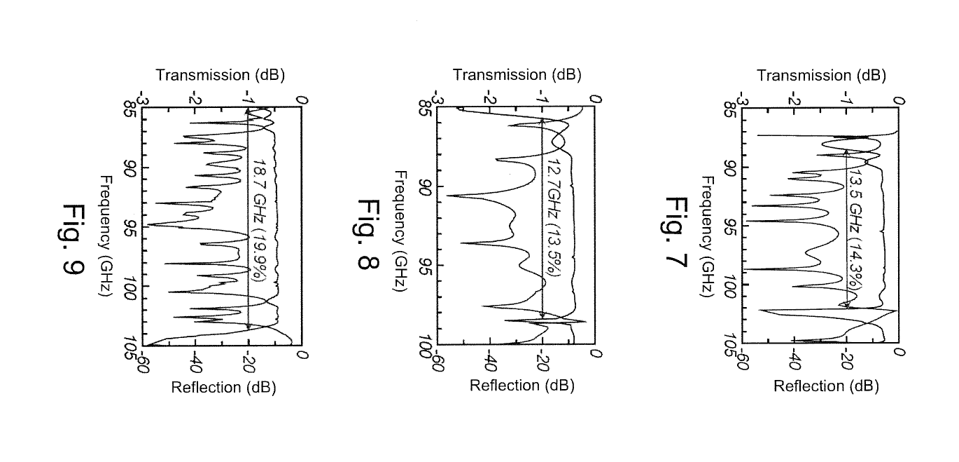

The radius of the outer interface 111b of the second waveguide 11b of the second mode converting structure 10b is 4.60 mm and 2.80 mm is for the inner interface; the radius ratio rₒ/rᵢ is 1.64. Simulation results are demonstrated in FIG. 8. TE₀₁ mode electromagnetic wave with 99.9% purity can be obtained via the second mode converting structure 101), wherein the −1 dB transmission bandwidth is generated from 86 GHz to 98 GHz (12.7%).

The radius of the outer interface 111c of the third waveguide 11c of the third mode converting structure 10c is 7.20 mm and 5.30 mm is for the inner interface; the radius ratio rₒ/rᵢ is 1.36. Simulation results are demonstrated in FIG. 9. The −1 dB transmission bandwidth is generated from 85 GHz to 104 GHz.

It should be noticed that the innermost layer, i.e. the first waveguide 11a, is described in the form of coaxial waveguide, but not limited to this. People who are skilled in art shall understand that the first waveguide 11a also can be a circle waveguide, that is to say, even though there is no inner interface 112a, the multi-channel mode converter operating with a series of TE or TM mode electromagnetic wave of the present invention still can be fulfilled.

Referring to FIG. 2 and FIG. 3, the multi-channel mode rotary joint operating with a series of TE or TM mode electromagnetic wave according to an embodiment of the present invention comprises two waveguide elements. Structure of the waveguide elements is described before and will not be elaborated any longer. The second output/input port 14a, 14b and 14c of the first mode converting structure 10a, the second mode converting structure 10b and the third mode converting structure 10c are arranged oppositely and coaxially. Accordingly, TE₀₁ mode electromagnetic wave stimulated by mode converter of any transmitting channel is not influenced by mutual rotation of two waveguide elements and oscillation direction of the TE₀₁ mode electromagnetic wave is axially parallel to the coaxial waveguides. Thus, energy of the TE₀₁ mode electromagnetic wave will not escape from the space between two waveguide elements to interfere other channels and further prevents crosstalk between channels.

It should be noticed that TE₀₁ mode electromagnetic wave is used while operating in aforementioned embodiments, but not limited to this. People who are skilled in art shall understand that other TE modes or TM series mode electromagnetic waves also can be used while operating. For example, by properly designing the spacing structure between two waveguide elements to form a choke type rotary joint, energy of radial direction can be decreased and further reduces crosstalk between channels.

In conclusion, the present invention relates to a multi-channel mode converter and rotary joint operating with a series of TE or TM mode electromagnetic wave, wherein a plurality of coaxial waveguides are sleeved to each other. By controlling radius ratio of each coaxial waveguide and the number of the coupling apertures, high power and high purity electromagnetic wave can be obtained and major competition mode electromagnetic waves can be suppressed, which prevents crosstalk between each coaxial waveguide.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A multi-channel mode converter operating with a series of TE or TM mode electromagnetic wave comprising a waveguide element, wherein the waveguide element comprises:
a first mode converting structure, which comprises:
a first waveguide with a circular outer interface; and
N first rectangular waveguides, wherein a first port thereof is respectively connected to the outer interface of the first waveguide and arranged uniform radially; a long axis of the first port of the first rectangular waveguide is axially parallel to the first waveguide; a second port of the N first rectangular waveguides forms at least one first output/input port of the first mode converting structure, wherein N is a positive integer greater than 1; and
a second mode converting structure, which comprises:
a second waveguide with an outer interface and an inner interface which are circular and coaxially-arranged, wherein the first waveguide is sleeved into the second waveguide; and
M second rectangular waveguides, wherein a first port thereof is respectively connected to the outer interface of the second waveguide and arranged uniform radially; a long axis of the first port of the second rectangular waveguide is axially parallel to the second waveguide; a second port of the M second rectangular waveguides forms at least one first output/input port of the second mode converting structure, wherein M is a positive integer greater than 1;
wherein a port of the first waveguide and the second waveguide respectively forms a second output/input port of the first mode converting structure and the second mode converting structure.

2. The multi-channel mode converter operating with a series of TE or TM mode electromagnetic wave according to claim 1, wherein the first waveguide further comprises a circular inner interface arranged coaxially with the outer interface of the first waveguide.

3. The multi-channel mode converter operating with a series of TE or TM mode electromagnetic wave according to claim 1, wherein the second ports of the N first rectangular waveguides converge into a single port, which is the first output/input port of the first mode converting structure.

4. The multi-channel mode converter operating with a series of TE or TM mode electromagnetic wave according to claim 1, wherein the second ports of the M second rectangular waveguides converge into a single port which is the first output/input port of the second mode converting structure.

5. The multi-channel mode converter operating with a series of TE or TM mode electromagnetic wave according to claim 1, wherein N is equal to 2ⁿ and any two adjacent of the first rectangular waveguides converge into a Y-shaped or T-shaped structure and n is a positive integer equal to or greater than 2.

6. The multi-channel mode converter operating with a series of TE or TM mode electromagnetic wave according to claim 1, wherein M is equal to 2ⁿ and any two adjacent of the second rectangular waveguides converge into a Y-shaped or T-shaped structure and n is a positive integer equal to or greater than 3.

7. The multi-channel mode converter operating with a series of TE or TM mode electromagnetic wave according to claim 1, wherein each of the first rectangular waveguides faces the second output/input port of the first mode converting structure to axially extend an arc protrusion at the first port of the first rectangular waveguide.

8. The multi-channel mode converter operating with a series of TE or TM mode electromagnetic wave according to claim 1, wherein each of the second rectangular waveguides faces the second output/input port of the second mode converting structure to axially extend an arc protrusion at the first port of the second rectangular waveguide.

9. The multi-channel mode converter operating with a series of TE or TM mode electromagnetic wave according to claim 1, wherein the first port of at least one of the first rectangular waveguide and the second rectangular waveguide is tetragonal symmetry in shape.

10. The multi-channel mode converter operating with a series of TE or TM mode electromagnetic wave according to claim 1, further comprising a conductive plate covering the first port of at least one of the first rectangular waveguide and the second rectangular waveguide, wherein the conductive plate comprises at least one coupling aperture which is stripe-like and tetragonal symmetry in shape, and the long axis thereof is axially parallel to the first waveguide or the second waveguide.

11. The multi-channel mode converter operating with a series of TE or TM mode electromagnetic wave according to claim 1, wherein the waveguide element further comprises:
a third mode converting structure, which comprises:
a third waveguide with an outer interface and an inner interface which are circular and coaxially-arranged, wherein the second waveguide is sleeved into the third waveguide; and
L third rectangular waveguides, wherein a first port thereof is respectively connected to the outer interface of the third waveguide and is arranged uniform radially; a long axis of the first port of the third rectangular waveguide is axially parallel to the third waveguide; a second port of the L second rectangular waveguides forms at least one first output/input port of the third mode converting structure, wherein L is a positive integer greater than 1;
wherein a port of the third waveguide forms a second output/input port of the third mode converting structure.

12. The multi-channel mode converter operating with a series of TE or TM mode electromagnetic wave according to claim 11, wherein the second ports of the L third rectangular waveguides converge into a single port, which is the first output/input port of the third mode converting structure.

13. The multi-channel mode converter operating with a series of TE or TM mode electromagnetic wave according to claim 11, wherein L is equal to 2ⁿ and any two adjacent of the third rectangular waveguides converge into a Y-shaped or T-shaped structure and n is a positive integer equal to or greater than 4.

14. The multi-channel mode converter operating with a series of TE or TM mode electromagnetic wave according to claim 11, wherein each of the third rectangular waveguides faces the second output/input port of the third mode converting structure to axially extend an arc protrusion at the first port of the third rectangular waveguide.

15. The multi-channel mode converter operating with a series of TE or TM mode electromagnetic wave according to claim 1, wherein the second output/input port of at least one of the first mode converting structure and the second mode converting structure is used to receive or output a electromagnetic wave with properties of toroidal surface current.

16. The multi-channel mode converter operating with a series of TE or TM mode electromagnetic wave according to claim 1, wherein the electromagnetic wave comprises TE_{N} mode electromagnetic wave.

17. A multi-channel rotary joint operating with a series of TE or TM mode electromagnetic wave comprising two waveguide elements, wherein each of the waveguide elements comprises:
a first mode converting structure, which comprises:
a first waveguide with a circular outer interface; and
N first rectangular waveguides, wherein a first port thereof is respectively connected to the outer interface of the first waveguide and arranged uniform radially; a long axis of the first port of the first rectangular waveguide is axially parallel to the first waveguide; a second port of the N first rectangular waveguides forms at least one first output/input port of the first mode converting structure, wherein N is a positive integer greater than 1; and
a second mode converting structure, which comprises:
a second waveguide with an outer interface and an inner interface which are circular and coaxially-arranged, wherein the first waveguide is sleeved into the second waveguide; and
M second rectangular waveguides, wherein a first port thereof is respectively connected to the outer interface of the second waveguide and arranged uniform radially; a long axis of the first port of the second rectangular waveguide is axially parallel to the second waveguide; a second port of the M second rectangular waveguides forms at least one first output/input port of the second mode converting structure, wherein M is a positive integer greater than 1;
wherein a port of the first waveguide and the second waveguide respectively forms a second output/input port of the first mode converting structure and the second mode converting structure, and the two waveguide elements are coaxially arranged as the second output/input ports are arranged in opposition.

18. The multi-channel rotary joint operating with a series of TE or TM mode electromagnetic wave according to claim 17, wherein the first waveguide further comprises a circular inner interface arranged coaxially with the outer interface of the first waveguide.

19. The multi-channel rotary joint operating with a series of TE or TM mode electromagnetic wave according to claim 17, wherein the second ports of the N first rectangular waveguides converge into a single port, which is the first output/input port of the first mode converting structure.

20. The multi-channel rotary joint operating with a series of TE or TM mode electromagnetic wave according to claim 17, wherein the second ports of the M second rectangular waveguides converge into a single port, which is the first output/input port of the second mode converting structure.

21. The multi-channel rotary joint operating with a series of TE or TM mode electromagnetic wave according to claim 17, wherein N is equal to 2″ and any two adjacent of the first rectangular waveguides converge into a Y-shaped or T-shaped structure and n is a positive integer equal to or greater than 2.

22. The multi-channel rotary joint operating with a series of TE or TM mode electromagnetic wave according to claim 17, wherein M is equal to 2ⁿ and any two adjacent of the second rectangular waveguides converge into a Y-shaped or T-shaped structure and n is a positive integer equal to or greater than 3.

23. The multi-channel rotary joint operating with a series of TE or TM mode electromagnetic wave according to claim 17, wherein each of the first rectangular waveguides faces the second output/input port of the first mode converting structure to axially extend an arc protrusion at the first port of the first rectangular waveguide.

24. The multi-channel rotary joint operating with a series of TE or TM mode electromagnetic wave according to claim 17, wherein each of the second rectangular waveguides faces the second output/input port of the second mode converting structure to axially extend an arc protrusion at the first port of the second rectangular waveguide.

25. The multi-channel rotary joint operating with a series of TE or TM mode electromagnetic wave according to claim 17, wherein the first port of at least one of the first rectangular waveguide and the second rectangular waveguide is tetragonal symmetry in shape.

26. The multi-channel rotary joint operating with a series of TE or TM mode electromagnetic wave according to claim 17, further comprising a conductive plate covering the first port of at least one of the first rectangular waveguide and the second rectangular waveguide, wherein the conductive plate comprises at least one coupling aperture which is stripe-like and tetragonal symmetry in shape, and the long axis thereof is axially parallel to the first waveguide or the second waveguide.

27. The multi-channel rotary joint operating with a series of TE or TM mode electromagnetic wave according to claim 17, wherein the waveguide element further comprises:
a third mode converting structure, which comprises:
a third waveguide with an outer interface and an inner interface which are circular and coaxially-arranged, wherein the second waveguide is sleeved into the third waveguide; and
L third rectangular waveguides, wherein a first port thereof is respectively connected to the outer interface of the third waveguide and is arranged uniform radially; a long axis of the first port of the third rectangular waveguide is axially parallel to the third waveguide; a second port of the L second rectangular waveguides forms at least one first output/input port of the third mode converting structure, wherein L is a positive integer greater than 1;
wherein a port of the third waveguide forms a second output/input port of the third mode converting structure.

28. The multi-channel rotary joint operating with a series of TE or TM mode electromagnetic wave according to claim 27, wherein the second ports of the L rectangular waveguides converge into a single port, which is the first output/input port of the third mode converting structure.

29. The multi-channel rotary joint operating with a series of TE or TM mode electromagnetic wave according to claim 27, wherein L is equal to 2ⁿ and any two adjacent of the third rectangular waveguides converge into a Y-shaped or T-shaped structure and n is a positive integer equal to or greater than 4.

30. The multi-channel rotary joint operating with a series of TE or TM mode electromagnetic wave according to claim 27, wherein each of the third rectangular waveguides faces the second output/input port of the third mode converting structure to axially extend an arc protrusion at the first port of the third rectangular waveguide.
